(19) United States
(12) Patent Application Publication
(10) Pub. No.: US 2014/0358796 A1
(43) Pub. Date: Dec. 4, 2014

(54) Methods and Apparatus for Performing Local Transactions

(71) Applicant: MASTERCARD INTERNATIONAL INCORPORATED, Purchase, NY (US)

(72) Inventors: Patrik Smets, Waterloo (BE); Axel Cateland, Purchcase, NY (US)

(73) Assignee: MASTERCARD INTERNATIONAL INCORPORATED, Purchase, NY (US)

(21) Appl. No.: 14/293,752

(22) Filed: Jun. 2, 2014

(30) Foreign Application Priority Data
Jun. 3, 2013 (GB) 1309880.1

(51) Int. Cl. G06Q 20/38; G06Q 20/40; G06Q 20/32

(52) U.S. Cl. CPC G06Q 20/38215; G06Q 20/322; G06Q 20/401; G06Q 2220/00
USPC 705/76

(57) ABSTRACT

A method of performing a transaction using first and second computing devices is described. A local data connection is established between the first computing device and the second computing device. An amount to transfer is identified at either the first computing device or the second computing device. A first account is identified at the first computing device and a second account at the second computing device. Credentials are provided at the first computing device to authorize the transaction, and encrypted and authenticated transaction data is sent to a payer account provider for value transfer between the first account provider and a second account provider. Confirmation of the completed transaction is then provided to the first computing device and the second computing device. Suitable computer program products and computing devices are provided. This method is particularly effective for providing local person to person value transfers in real time.

### FIELD

The present disclosure generally relates to methods and apparatus for performing local transactions. In exemplary embodiments, the present disclosure provides methods and apparatus to allow local financial transactions to be made between computing devices, preferably portable computing devices such as mobile telephones, acting as proxies for payment cards.

### BACKGROUND

Payment cards, such as credit cards and debit cards, are very widely used for all forms of financial transaction. The use of payment cards has evolved significantly with technological developments over recent years. Originally, transactions were on paper, using an imprint of a transaction card and confirmed by a signature. This approach was largely replaced by use of a magnetic stripe of a transaction card swiped through a magnetic stripe reader on a point of sale (POS) terminal to perform a transaction. Transaction cards developed to contain an integrated circuit (“chip cards” or “smart cards”) communicate with a smart card reader in the POS terminal. Using this approach, a transaction is typically confirmed by a personal identification number (PIN) entered by the card user. Cards of this type typically operate under the EMV standard for interoperation of chip cards and associated apparatus (such as POS terminals and ATMs). ISO/IEC 7816 provides a standard for operation of cards of this type.

Technology has further developed to provide payment cards which operate contactlessly; under EMV, these are covered under the ISO/IEC 14443 standard. Using such cards, the account number can be read automatically from the card by a POS terminal, generally using a short range wireless technology such as Near Field Communications (NFC)—this approach is generally referred to as “contactless” or “proximity” payment. This is typically enabled by embedding of an NFC tag in a card body together with a suitable antenna to allow transmission and receipt of wireless signals—the transmissions may be powered by a radio frequency interrogation signal emitted by a proximity reader in the POS terminal. For an effective connection to be made, the payment card may need to be brought into very close proximity to the proximity reader—this has security benefits and prevents confusion if there are multiple enabled payment cards in the general vicinity of the proximity reader, as will typically be the case in a retail establishment for example. This may be achieved by tapping the antenna of the payment card against the proximity reader of the POS terminal.

The present applicants have developed a proprietary system, known as PayPass®, for performing contactless transactions. The present applicants have also appreciated that it would be possible to use a computing device such as a mobile telephone as a proxy for a payment card. They have also developed a mobile payment application, Mobile PayPass™, which can be downloaded to a mobile cellular telephone handset or the secure element in a handset (hereafter “mobile phone”) to act as a proxy for a payment card using Near Field Communication (NFC) technology standards, which are built in to the majority of current mobile phones. NFC is a development upon RFID, and NFC-enabled devices are able to operate in the same manner as RFID devices. Using Mobile PayPass™, a user can conduct tapping based transactions with a proximity reader, as well as perform account management operations over an appropriate network interface (cellular, local wireless network) in an online banking interface with the user's account provider.

While this paradigm is used effectively for retail transactions, it has not been used effectively for person-to-person money transfer. Money transfer of this kind is generally not achievable in a person-to-person interaction, but rather in a first set of interactions by a first party with a service provider to initiate the transfer, and a second set of interactions at a later time by a receiving party with the same (or another) service provider to access the transferred funds. These typically include registration of each participant for the service, a requirement for KYC (Know Your Customer) legal requirements to be met, and an information exchange between the parties which allows the transaction to be formulated. This applies even when the two parties are physically close to each other. It would be desirable to provide a more effective person-to-person transfer when both parties are present in a locality.

### SUMMARY

In a first aspect, the present disclosure provides a method of performing a transaction using a first computing device and a second computing device, the method comprising: establishing a local data connection between the first computing device and the second computing device; identifying an amount to transfer at either the first computing device or the second computing device; identifying a first account at the first computing device and a second account at the second computing device; providing one or more credentials at the first computing device to authorise the transaction, and sending encrypted and authenticated transaction data to a first account provider for value transfer between the first account provider and a second account provider; and providing confirmation of the completed transaction to the first computing device and the second computing device.

This transaction may be financial, in which case the first account may be a payer account, the second account a payee account, and the value transfer a credit. This approach is extremely effective to extend the contactless card transaction paradigm to person to person credit transfer, which can be performed locally and in real time using this approach. However, the present disclosure is not limited to this field of use—it can be used in other areas, such as in the authorisation of a second party to access privileged information by a first party.

Preferably, the method further comprises exchanging a verifiable token between the first and second computing devices as proof of the outcome of the transaction.

Preferably, one or both of the mobile computing devices are mobile cellular telecommunications handsets. The local data connection comprises a local point to point connection, such as a Bluetooth connection—it is particularly effective if communication uses NFC protocols and so closely emulates existing contactless transaction technologies, particularly as this allows devices already enabled for NFC to use this approach.

Alternatively, the local data connection may be a network connection such as an 802.11 connection. Other approaches, such as exchange of QR codes or audio communications using speaker and microphone may be used to achieve local data communication without a local network.

Preferably, the local data connection is used to extract information related to the first account for creating a value transfer transaction.

Preferably, authenticated transaction data is provided with two factor authentication. A user PIN may be provided as a knowledge factor, and the first computing device may generate a cryptogram to provide a possession factor.

Preferably, the value transfer is processed using a real-time payment authorisation network. Preferably the value transfer is confirmed real-time to both first and second computing devices. The outcome of the value transfer may be summarized in a non-repudiable token that can be verified by both parties.

In a second aspect, the present disclosure provides a method at a first computing device for making a value transfer to a second computing device, the method comprising: establishing a local data connection with the second computing device; identifying an amount to transfer; identifying a first account; providing one or more credentials to authorise the transaction, and sending encrypted and authenticated transaction data to a first account provider for value transfer between the first account provider and a second account provider; and receiving confirmation of the completed transaction from the first account provider.

Preferably, the method further comprises generating a non-repudiable and verifiable token on a successful transaction outcome and delivering this token to the second computing device.

In a third aspect, the present disclosure provides a method at a second computing device for receiving a value transfer from a first account associated with a first computing device, the method comprising: establishing a local data connection with the first computing device; identifying a second account at the second computing device, and providing payee account information to the first computing device; and receiving confirmation of the completed transaction from a second account provider.

Preferably, the method further comprises generating a non-repudiable and verifiable token on an unsuccessful transaction outcome and delivering this token to the other device.

In a fourth aspect, the present disclosure provides a computing device having a processor and a memory, wherein the processor is programmed to perform the method of the second aspect or the third aspect. Advantageously, the computing device further comprises an NFC controller, and preferably the computing device is a mobile cellular telecommunications handset.

In a fifth aspect, the present disclosure provides a computer program product stored on a physical medium, wherein the computer program product is adapted to program a processor of a computing device to perform the method of the second aspect or the third aspect.

### DRAWINGS

Embodiments of the present disclosure will now be described, by way of example, with reference to the accompanying Figures, of which:

FIG. 1 shows relevant parts of a representative hardware and software architecture for a mobile computing device suitable for implementing an embodiment of the present disclosure;

FIG. 2 illustrates schematically elements of an embodiment of the present disclosure in association with relevant hardware elements and network connections;

FIG. 3 provides a flow diagram illustrating steps of a method according to the present disclosure;

FIG. 4 provides a screenshot of a mobile phone display on initiation of a money transfer application according to an embodiment of the present disclosure;

FIGS. 5A and 5B provide screenshots of mobile phone displays of a payer and a payee device respectively after initiation of a money transfer application as shown in FIG. 4 but before initiation of a local network connection between them;

FIGS. 6A and 6B provide screenshots of a mobile phone display of a payer device after initiation of a local network connection with a payee device as shown in FIG. 5A and during establishment of an amount for transfer to the payee;

FIG. 7 provides a screenshot of a mobile phone display of a payer device after establishment of an amount to transfer to the payee as shown in FIG. 6B and before validation of a selection of a payment card to transfer funds from;

FIG. 8 provides a screenshot of a mobile phone display of a payer device after validation of a payment card selection as shown in FIG. 7 and during composition of a message to accompany a transfer;

FIG. 9 provides a screenshot of a mobile phone display of a payer device after composition of a message to accompany a transfer as shown in FIG. 8 and during entry of a PIN to validate the transaction; and

FIG. 10 provides a screenshot of a mobile phone display of a payer or a payee device after validation of the transaction while waiting for confirmation that the credit transfer has been completed.

### DETAILED DESCRIPTION

Specific embodiments of the present disclosure will be described below with reference to the Figures.

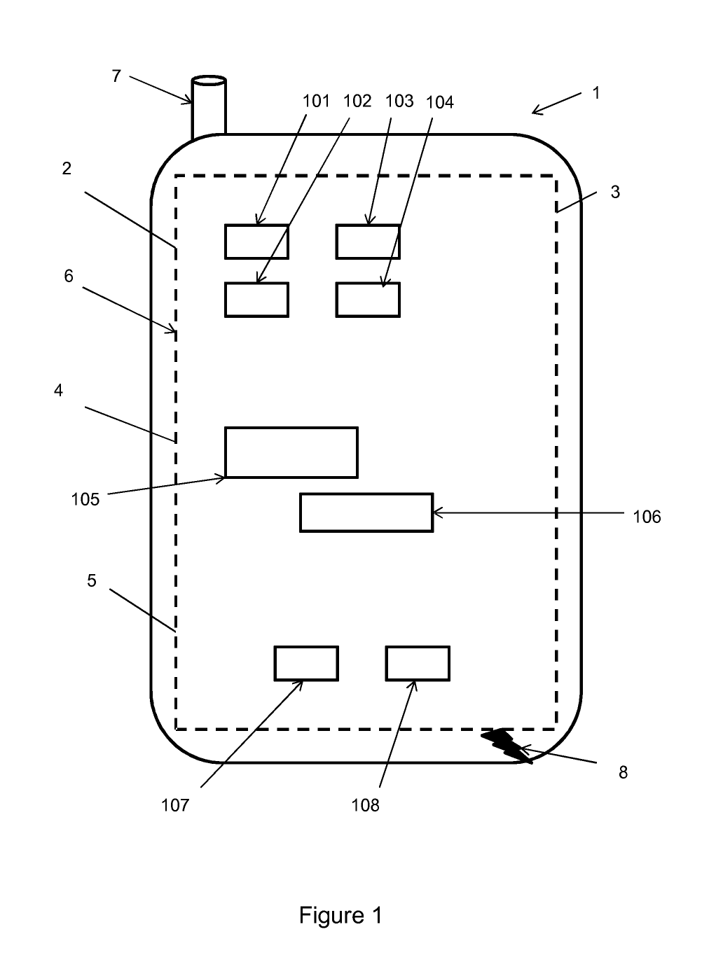

FIG. 1 shows schematically relevant parts of a representative hardware and software architecture for a mobile computing device suitable for implementing an embodiment of the present disclosure. In the example shown, each mobile computing device is a mobile cellular telecommunications handset (“mobile phone” or “mobile device”)—in other embodiments, the computing device may be another type of computing device such as a laptop computer or a tablet, the computing device need not have cellular telecommunications capabilities, and one of the computing devices need not even be mobile (in principle, embodiments of the present disclosure could be provided in which neither computing device were mobile, though in most practical applications envisaged at least one computing device would be mobile).

Mobile phone 1 comprises an application processor 2, one or more memories 3 associated with the application processor, a SIM, SE or USIM 4 itself comprising both processing and memory capabilities and a NFC controller 5. The terms SIM and USIM refer to Subscriber Identification Module and Universal Subscriber Identification Module respectively, and are standard terms of art in cellular telephony covered by appropriate GSM and UMTS standards—SE refers to a Secure Element, which is a tamper-resistant platform, normally implemented as a chip, capable of securely hosting applications and their confidential and cryptographic data The mobile phone also has a display 6 (shown as an overlay to the schematically represented computing elements of the device), providing in this example a touchscreen user interface. The mobile phone is equipped with wireless telecommunications apparatus 7 for communication with a wireless telecommunications network and local wireless communication apparatus 8 for interaction by NFC.

In the arrangement shown, the application processor 2 and associated memories 3 comprise (shown within the processor space, but with code and data stored within the memories) a money transfer application 101 and an associated mobile payment application 102 (which may be the applicant's Mobile PayPass, for example). It will also contain other applications normally needed by such a device, such as a browser 103 and a modem 104. The SE/SIM/USIM 4 will comprise a security domain 105 adapted to support cryptographic actions and an NFC application 106 which interfaces with the NFC controller 5, which has interfaces 107 to NFC devices and tags—this may also provide card emulation 108 to allow the mobile phone 1 to emulate a contactless card.

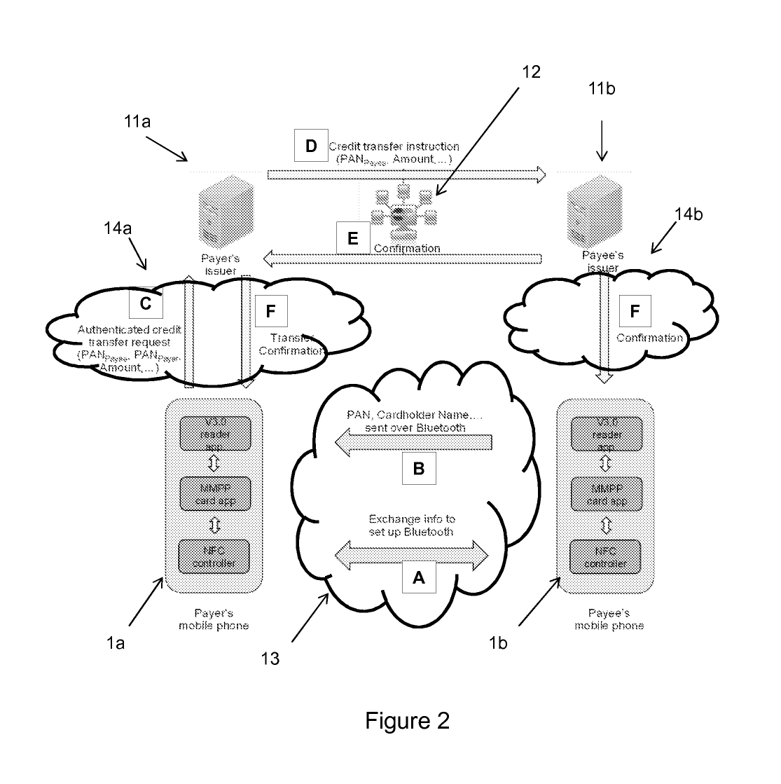

FIG. 2 illustrates schematically elements of an embodiment of the present disclosure in association with relevant hardware elements and network connections. A payer mobile phone 1a and a payee mobile phone 1b are associated with an payer card issuer 11a and a payee card issuer 11b. These card issuers are connected by an existing transaction authorisation infrastructure 12, particularly one that can provide real time authorisation. A local network or connection 13 is established between the two mobile phones 1a and 1b, and each mobile phone itself communicates with its issuer over an appropriate transport channel and network 14a and 14b (which may use a cellular telecommunications network or a direct or local network connection to the public internet). Method steps A to F illustrated in FIG. 2 will be described in more detail below.

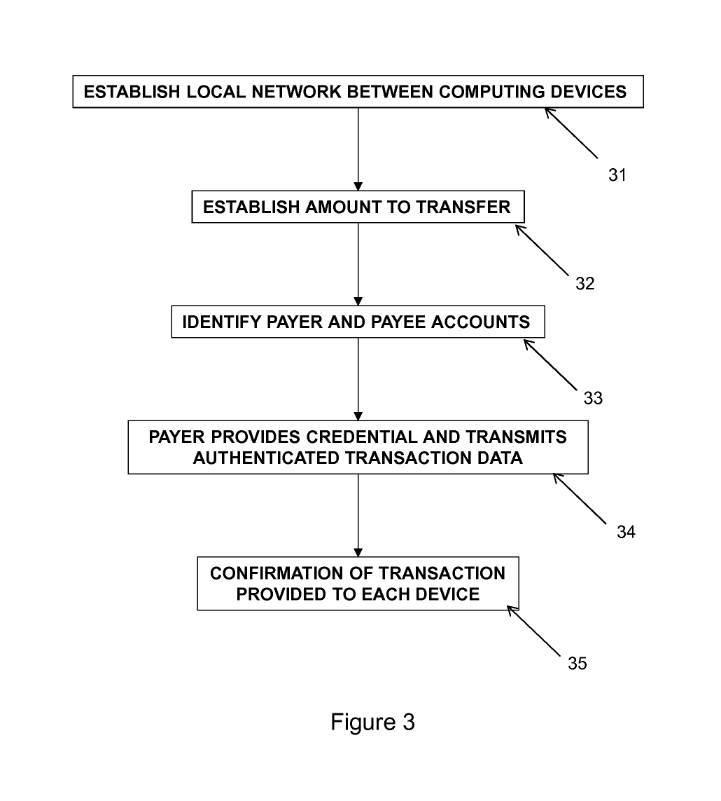

FIG. 3 provides a flow diagram illustrating steps of a method according to the present disclosure. A local network or communication is established 31 between the payer computing device 1a and the payee computing device 1b. An amount to transfer is established 32 at one of the computing devices. Payer and payee accounts are identified 33 at each computing device. At least one credential is provided at the payer computing device enabling authenticated transaction data to be provided 34 by the payer computing device to the payer's card issuer. Confirmation of the completed transaction is then provided 35 to each computing device.

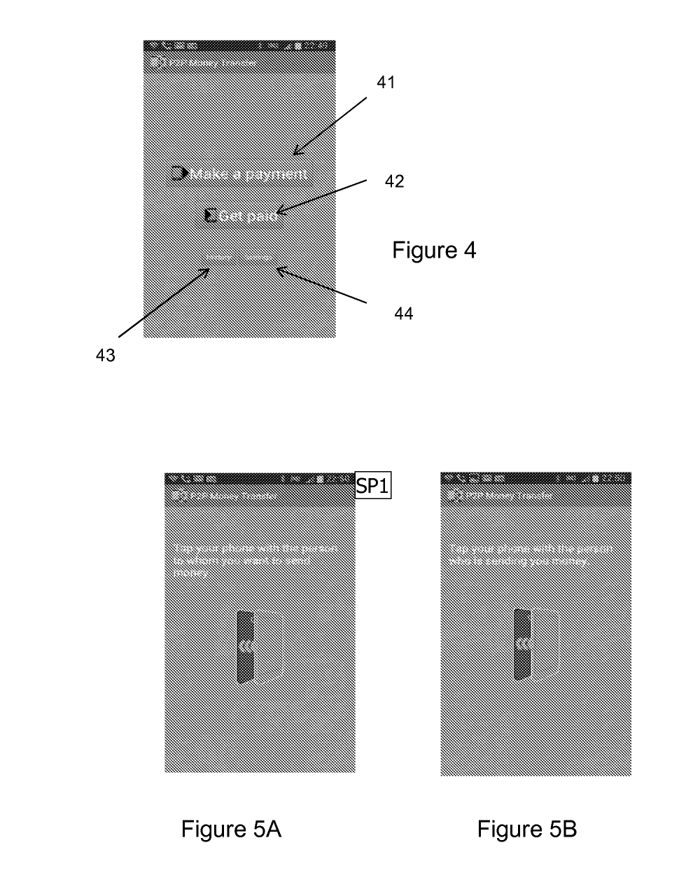

Individual steps of the method shown in FIGS. 2 and 3 will now be described with reference to FIGS. 4 to 10, which provide screenshots of payer and payee mobile phone displays during performance of a method according to an embodiment of the present disclosure. Associated apparatus and program products are described, also according to embodiments of the present disclosure.

As indicated with reference to FIG. 1, in embodiments the method may be initiated by launching a suitable application on each computing device. FIG. 4 shows a screenshot of either mobile phone after the money transfer application has been launched. The user is presented with the two main options of making a payment 41 or receiving a payment 42—other options such as obtaining a transaction history 43 or changing application settings 44 (such as adding or removing a linked account) may also be available. In this example, it is assumed that there are two devices, one representing a payer and the other a payee—the payer will select “making a payment” 41, and the payee will select “get paid” 42.

FIGS. 5A and 5B show screenshots to urge the users to take the next step, which is to bring the two mobile phones into proximity to establish a Bluetooth connection between the two over the NFC interface. As the screenshots indicate, a physical tap between the devices is required to establish this local connection. This is a similar approach to that usually followed when making contactless card payments using NFC. NFC will be implemented in a way appropriate to the mobile phone (or other computing device) and the protocol used may vary. For example, in a mobile phone running a version of the Android operating system, the information needed to set up the local data connection may be exchanged through Android Beam (in an Initiator/Target configuration). It may equally be exchanged by having one of the devices act as a tag (i.e. reader/card emulation configuration).

The establishment of a local network or connection is also shown as step A on FIG. 2.

The skilled person will appreciate that alternative approaches to NFC may be used to make a dedicated connection between the two mobile phones—for example, QR codes may be generated at one device for reading by the other device or audio signals may be used by means of the microphones & speakers of the respective phones.

Equally, alternative approaches to Bluetooth can be used for the local data connection between the two devices, such as a local 802.11 (WiFi) network—though the use of a wider range network increases the risk of interception, so if this approach is taken additional security measures may be taken to protect communication between the devices.

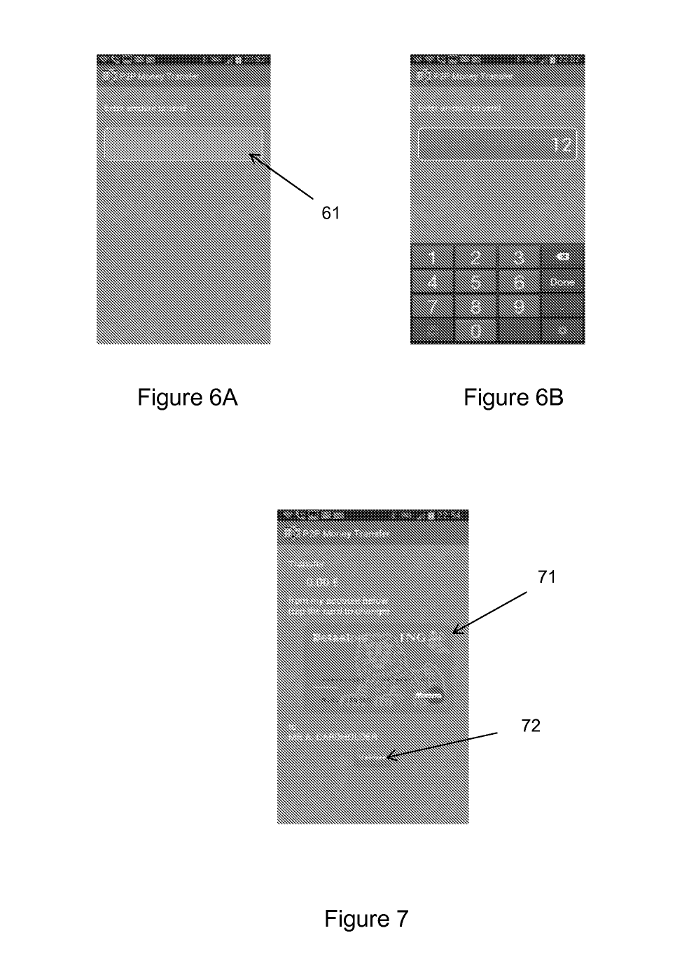

When the connection is established, both payer and payee will be provided with an amount entry box 61 as shown in FIG. 6A. In the embodiment shown here, either party may enter an amount to be transferred, but in principle this could be limited to only one of the two parties with the other party simply able to confirm or not confirm. When the amount is entered on one phone, it is shown in real time on the other phone through the Bluetooth connection between them—the screenshot shown in FIG. 6B of partially completed amount entry could therefore be of the phone of the amount entering party or the phone of the other party.

After the amount is entered (depending on implementation, this may be simply entered by one party or may need to be confirmed by the other party before the application proceeds), both the payer and the payee associate a card with the transaction. If the relevant party has only one card associated with the money transfer application, this step may be automatic, or may only require a simple confirmation to proceed 72 when the card details are shown 71, as shown in FIG. 7 which illustrates the screen of the payer device. If multiple cards are associated with the money transfer application, then there will be a card selection step allowing the relevant user to select the card to be used for the transaction.

Loading a card into a mobile handset is not discussed in detail here but is a routine part of existing card payment applications, such as the applicant's Mobile PayPass. It requires a registration process involving interaction with the card issuer to provide credentials and it needs to take place before payment credentials are loaded into the mobile handset. Registration and download of credentials need to take place before transactions are carried out. In principle, registration with the card issuer and download of card details can done remotely, over a suitable network connection (such as the cellular telecommunications network or a local wireless network connection to the public Internet).

The association of a card with the money transfer application may require a second registration process involving interaction with the card issuer to provide authorisation for this use and to make sure the card is labelled as eligible for this service in the payment network (such as the MoneySend service in the MasterCard MCW network), in which case this should take place before transactions are carried out.

Once the cards are selected, the payer receives from the payee the payee card details necessary for the payer to compose the transaction information. These will include at least one set of credentials to uniquely identify the payee's account for example the cardholder name and the PAN (Primary Account Number) of the payee card or the payee's account IBAN (or similar bank account reference), but may include other details if needed or desired as part of the transaction information used to establish or process a credit transfer between the payer and payee card issuers. This is shown as step B on FIG. 2.

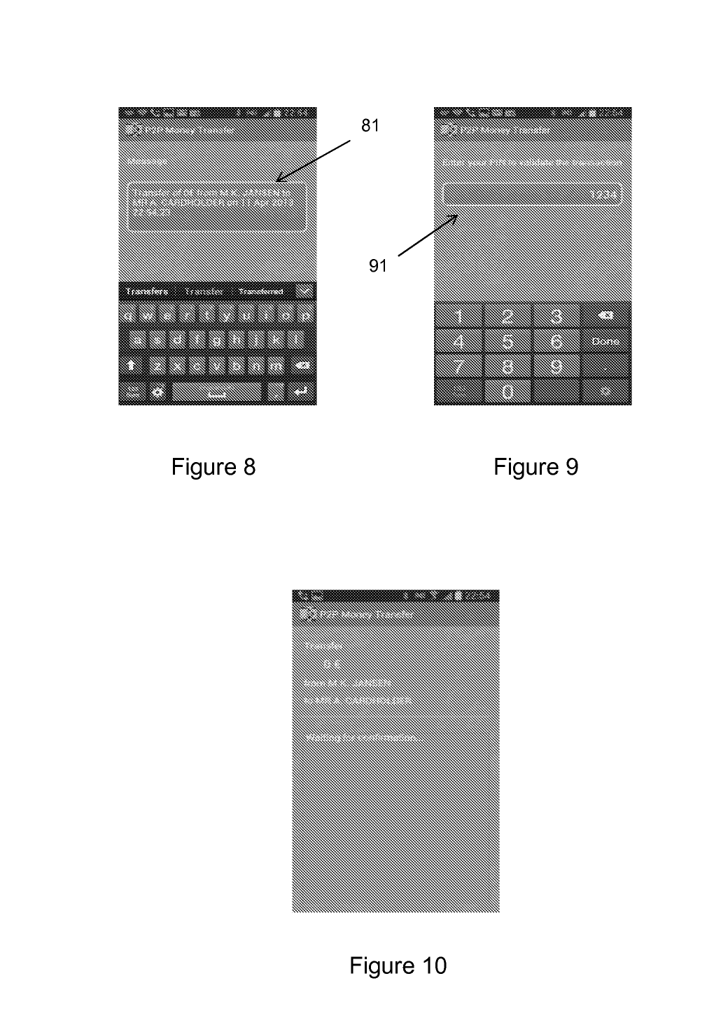

As shown in FIG. 8, a message 81 may be composed at the payer device for inclusion in the transaction information. This could be a predefined message, a modifiable predefined message, or simply a freeform text field—the purpose will generally be to allow the payer or payee to identify or classify the transaction at a later stage.

As shown in FIG. 9, before the transaction information is sent from the payer device to the payer card issuer, the payer enters a PIN (personal identification number) in a PIN field 91. This may be the same PIN as used in retail transactions or in cash withdrawal from an ATM, or may be a separate PIN associated with the money transfer application (or with a mobile banking application with which the money transfer application is associated). This PIN can be validated by the payment application in the Secure Element, SIM or USIM and the result of the validation included in the cryptogram generated by the payment application, using a secret key only known to the payment application and its issuer. This cryptogram is sent to the issuer as part of the credit transfer request. This provides a user credential allowing the payer card issuer to determine with some degree of confidence that the instruction has been received from the payer and not fraudulently from a third party.

The approach above illustrates multifactor authentication. Multifactor authentication involves use of two or more of the following three factors: knowledge (something the user knows); possession (something the user has) and inherence (something the user is). Two factor authentication using knowledge and possession can be achieved very effectively within this infrastructure. The card PIN is a knowledge factor. Possession of the mobile phone with a secret key in the payment application is a possession factor. This possession factor may be demonstrated by using an encryption capability provided in the money transfer application (or associated mobile banking application). For example, in the case of embodiments associated with Mobile PayPass, the possession factor may be demonstrated by use of a secret key within the application to generate an AC (Application Cryptogram), which will be sent from the payer device to the payer card issuer in step C of FIG. 2.

Multifactor authentication is used in the provision of a credit transfer instruction from the payer device to the payer card issuer, as shown in step C in FIG. 2. A credit transfer instruction is composed comprising the following data:
PAN (or equivalent) of the payer
PAN (or equivalent) of the payee
Amount (and currency code)
The message generated by the payer
A two factor authentication token protecting the above

The two factor authentication token is generated using the cardholder PIN entered on the payer mobile phone and an AC generated by the money transfer application.

The authenticated credit transfer instruction may be communicated from the payer device to the payer card issuer by any appropriate network. This may for example be over a local WiFi connection and the public Internet, or by GPRS over the cellular telecommunications network to which the payer device is attached. The communication is protected by the two factor authentication used, so may be over a publicly accessible channel.

To ensure the authenticity and confidentiality of the credit transfer and in addition to the authentication described above, the instruction can encrypted with the credentials securely enclosed in the payer card.

As shown in FIG. 10, while the credit transfer process takes place, a waiting screen is displayed on both devices. Credit transfer between the payer card issuer and the payee card issuer takes place in a conventional manner, as shown in FIG. 2. The authentication token is authenticated by the payer card issuer and the credit transfer instruction itself interpreted and the details of the transaction extracted, whereupon the balance of the payer account is checked to determine whether the transaction is to be allowed (if not, a rejection will be communicated back to the payer device). If the transaction is allowed, the payer card issuer provides (step D) a credit transfer instruction over an appropriate payment network (such as the MasterCard (MCW) network, which can provide real-time payment authorisation) to the payee card issuer. The payee card issuer accepts the transaction and sends a confirmation (step E) to the payer card issuer, at which point both card issuers know that the credit transfer has completed. Confirmations are then provided over an appropriate communication infrastructure (which may be any of the possibilities previously suggested for phone to card issuer communication such as the public Internet and WiFi or GPRS) to each of the two mobile phones (step F) from the appropriate card issuer. Clearing and settlement of the payment can take place at a later stage—the payer and payee card issuers have guaranteed the transaction, so confirmation can be provided to payer and payee.

The screen in FIG. 10 can then be replaced on each mobile device with a screen indicating that the transaction is complete. In this way, both payer and payee can receive a confirmation in real time (while still local to each other) that the money transfer is complete.

A record of the transaction is provided in the form of a non-repudiable token indicating the outcome of the transaction that can be verified by both parties. A token will typically be taken as non-repudiable if it is signed with a private key of that party or if it is signed with a private key of a party in an appropriate trust relationship with that party—this may be the account provider of that party, for example. One possibility is for the token to be generated by the payer device (using its private key so that verification can be made by the payee device with the associated public key) when the transaction is successful, so that the payer cannot subsequently repudiate the transaction. Similarly, if the transaction is unsuccessful, the token may be generated by the payee device so that the payer device cannot subsequently claim that the transaction succeeded. Generation of the token may be achieved in essentially similar fashion to generation of the encrypted transaction data for forwarding to the payer account provider.

This money transfer functionality may be provided as a discrete application, or may be provided within, or auxiliary to, a mobile banking or mobile transaction application such as Mobile PayPass. Using this approach, the tapping paradigm successfully used for transactions with a contactless card or an NFC device can be expanded to person to person credit transfer.

As the person skilled in the art will appreciate, modifications and variations to the above embodiments may be provided, and further embodiments may be developed, without departing from the spirit and scope of the present disclosure. Reference to standards and proprietary technologies are provided for the purpose of describing effective implementations, and do not limit the scope of the present disclosure.

1. A method of performing a transaction using a first computing device and a second computing device, the method comprising:
establishing a local data connection between the first computing device and the second computing device;
identifying an amount to transfer at either the first computing device or the second computing device;
identifying a first account at the first computing device and a second account at the second computing device;
providing one or more credentials at the first computing device to authorise the transaction, and sending encrypted and authenticated transaction data to a first account provider for a transfer between the first account provider and a second account provider; and
providing confirmation of the completed transaction to the first computing device and the second computing device.

2. A method as claimed in claim 1, further comprising exchanging a verifiable token between the first and second computing devices as proof of the outcome of the transaction.

3. A method as claimed in claim 1, wherein one or both of the computing devices are mobile cellular telecommunications handsets.

4. A method as claimed in claim 1, wherein the local data connection includes one or more of a Bluetooth connection, an NFC connection, and a local network connection.

5. (canceled)

6. A method as claimed in claim 1, wherein the local data connection comprises one or more of exchange of QR codes, and audio communication using speakers and microphones of the first and second computing devices.

7. (canceled)

8. (canceled)

9. A method as claimed in claim 1, wherein the local data connection is a local network connection, and wherein the local network connection is an 802.11 connection.

10. A method as claimed in claim 1, where the local data connection is used to extract information related to the first account for creating a value transfer transaction.

11. A method as claimed in claim 1, wherein authenticated transaction data is provided to the first account provider with value transfer instructions protected by two factor authentication.

12. A method as claimed in claim 11, wherein a user PIN is provided as a knowledge factor.

13. A method as claimed in claim 11, wherein the first computing device generates a cryptogram to provide a possession factor.

14. A method as claimed in claim 1, wherein the value transfer is processed using a real-time authorisation network.

15. A method as claimed in claim 1, wherein the value transfer is confirmed real-time to both first and second computing devices.

16. A method as claimed in claim 1, where the outcome of the value transfer is summarized in a non-repudiable token that can be verified by both parties.

17. A method at a first computing device for making a value transfer to a second computing device, the method comprising:
establishing a local data connection with the second computing device;
identifying an amount to transfer;
identifying a first account;
providing one or more credentials to authorise the transaction, and sending encrypted and authenticated transaction data to a first account provider for value transfer between the first account provider and a second account provider; and
receiving confirmation of the completed transaction from the first account provider.

18. A method as claimed in claim 17, further comprising generating a non-repudiable and verifiable token on a successful transaction outcome and delivering this token to the second computing device.

19. A method at a second computing device for receiving a value transfer from a first account associated with a first computing device, the method comprising:
establishing a local data connection with the first computing device;
identifying a second account at the second computing device, and providing second account information to the first computing device; and
receiving confirmation of the completed transaction from a second account provider.

20. A method as claimed in claim 19, further comprising generating a non-repudiable and verifiable token on an unsuccessful transaction outcome and delivering this token to the first computing device.

21. (canceled)

22. A method as claimed in claim 19, wherein at least one of the first and second computing devices comprises an NFC controller.

23. A method as claimed in claim 19, wherein at least one of the first and second computing devices is a mobile cellular telecommunications handset.

24. (canceled)

25. A method as claimed in claim 17, wherein at least one of the first and second computing devices comprises an NFC controller.

26. A method as claimed in claim 17, wherein at least one of the first and second computing devices is a mobile cellular telecommunications handset.
